(19) United States
(12) Patent Application Publication
(10) Pub. No.: US 2016/0279811 A1
(43) Pub. Date: Sep. 29, 2016

(54) BOX CUTTER STRUCTURE

(71) Applicant: HACKSAW & KNIFE MANUFACTORY CO., LTD., Taichung City (TW)

(72) Inventors: Yin-Han Huang, Taichung City (TW); Tien-Yu Huang, Taichung City (TW)

(21) Appl. No.: 14/671,325

(22) Filed: Mar. 27, 2015

(51) Int. Cl. B26B 1/08

(52) U.S. Cl. CPC B26B 1/08

(57) ABSTRACT

A box cutter structure includes a shell, a swinging member pivoted to the shell, a blade carrier slidingly disposed in the shell, and a linkage mechanism including first and second linkages. Two ends of the first linkage are pivoted respectively to the blade carrier and an end of the second linkage, and the other end of the second linkage pivoted to the tail end. An elastic recovery mechanism is connected with the blade carrier and the shell and has a tendency to actuate the blade carrier toward the tail end. When the swinging member swings toward the shell, the pivoting portion is pushed and abutted by the swinging member and moves forward, and the first linkage swings about the pivoting portion and pushes the blade carrier to move toward the blade-projecting end.

### BACKGROUND OF THE INVENTION

1. Field of the Invention

The present invention relates to a cutting tool, and more particularly to a box cutter structure.

2. Description of the Prior Art

Usually, a box cutter is light, sharp and convenient to cut objects, and the box cutter is widely used. The conventional box cutter generally includes a long blade carrier, a blade disposed on the blade carrier and a controller which can be pushed and pulled by a user's finger. Through the user's finger pushing or pulling the controller, the controller controls the blade to move forward or backward inside the blade carrier; that is, the blade can be moved forward to project an edge out of the blade carrier, or the blade can be moved backward to retreat back to the blade carrier. The above-mentioned structure is disclosed in TWM 487191 and TWM 435984.

However, in this conventional structure, the user has to push and pull the controller by finger when using the box cutter. In addition, when in a cutting process, a position-restricting structure (for example, a toothed slot) of the blade carrier needs to be stuck with the controller to restrict each other, and after use of the box cutter, the user needs to move the controller and release the controller and the position-restricting structure so as to retreat the blade.

In addition, in this conventional structure, the blade does not retreat automatically after use. It is dangerous that the blade does not retreat into the blade carrier immediately.

The present invention has arisen to mitigate and/or obviate the afore-described disadvantages.

### SUMMARY OF THE INVENTION

The major object of the present invention is to provide a box cutter structure which can project a blade through a linkage mechanism with a press. The present invention has a simple structure. The present invention retreats the blade automatically after use and locks the blade when being putting aside, so it is safe to use the box cutter structure, so it is convenient, energy-saving and safe for a user.

To achieve the above-mentioned and other objects, the present invention provides a box cutter structure, including: a shell, having a blade-projecting end and a tail end corresponding to the blade-projecting end; a swinging member, pivoted to the shell and extending toward the tail end to form an abutting end; a blade carrier, slidingly disposed in the shell and provided for carrying a blade; a linkage mechanism, including a first linkage and a second linkage, an end of the first linkage pivoted to the blade carrier, an end of the second linkage forming an included angle with the first linkage and pivoted with the other end of the first linkage to form a pivoting portion, the other end of the second linkage pivoted to the tail end, the pivoting portion being abuttable against the swinging member; an elastic recovery mechanism, connected with the blade carrier and the shell and having a tendency to actuate the blade carrier toward the tail end; wherein, when the swinging member swings toward the shell, the pivoting portion is pushed and abutted by the swinging member and moves forward, and the first linkage swings about the pivoting portion and pushes the blade carrier to move toward the blade-projecting end.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of a preferred embodiment of the present invention;

FIG. 2 is another perspective view of the preferred embodiment of the present invention;

FIG. 3 is a partial perspective view of the preferred embodiment of the present invention;

FIG. 4 is a breakdown drawing of the preferred embodiment of the present invention; and

FIGS. 5 to 7 are drawings showing the preferred embodiment of the present invention in use.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

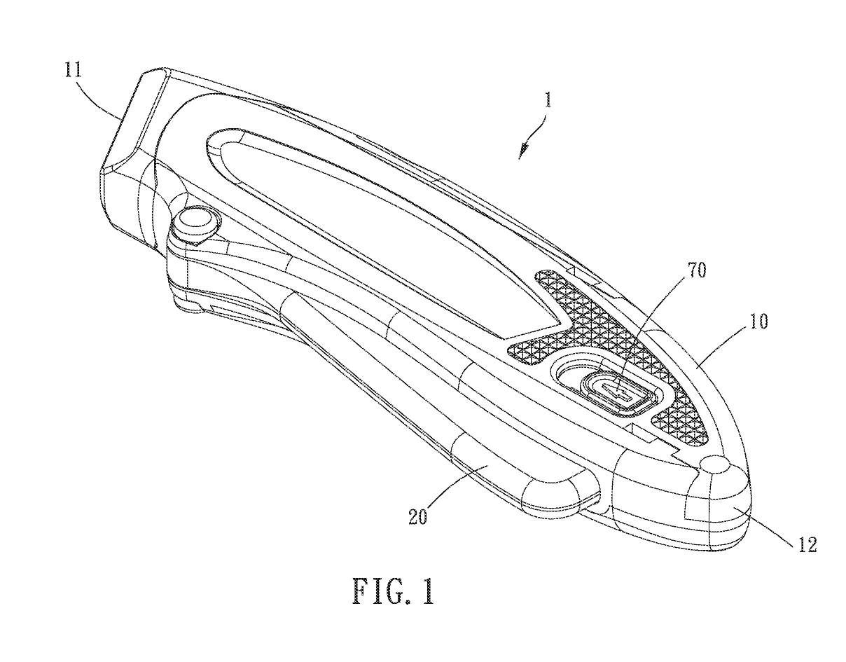

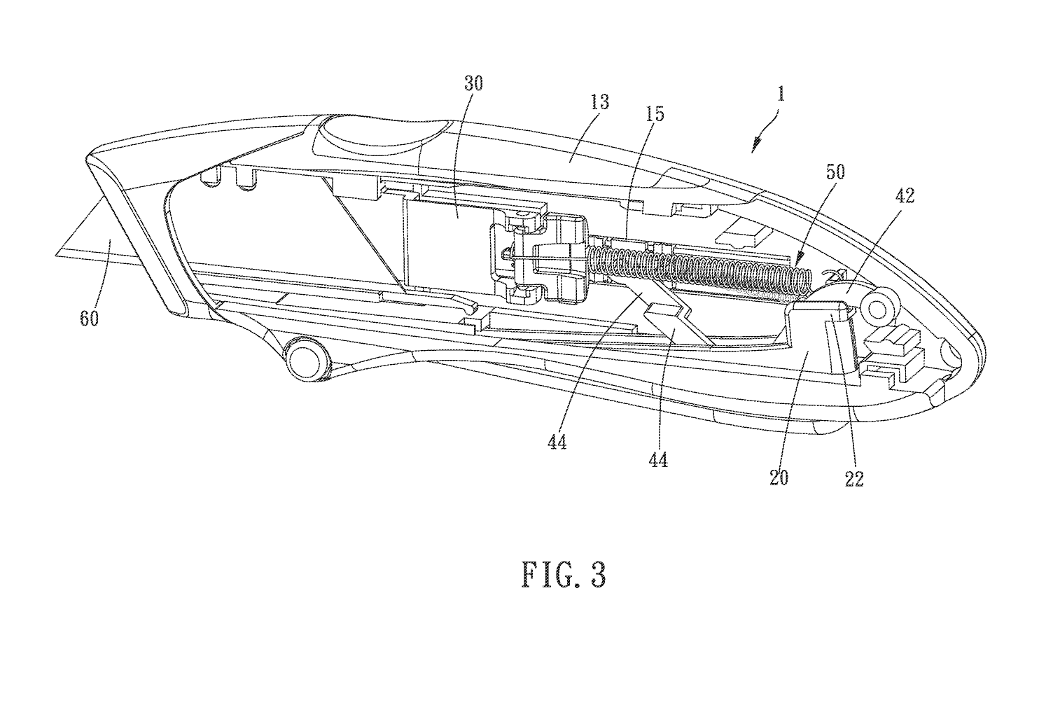

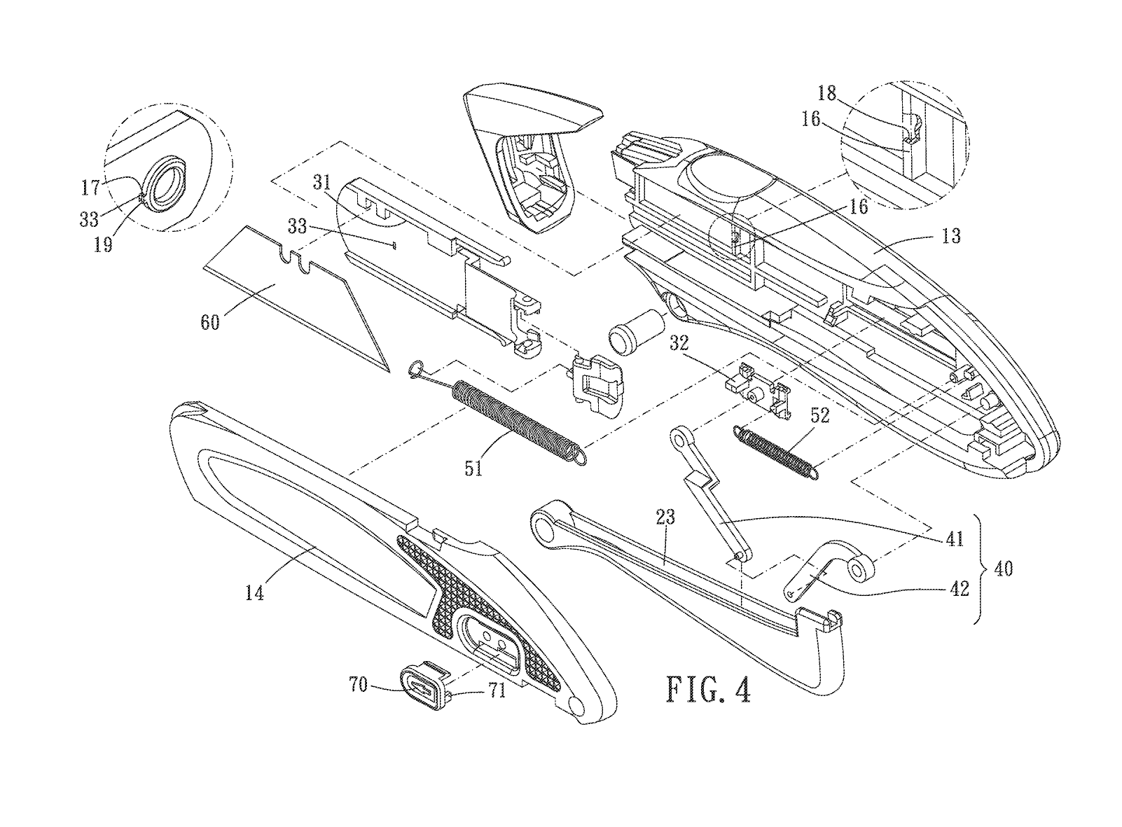

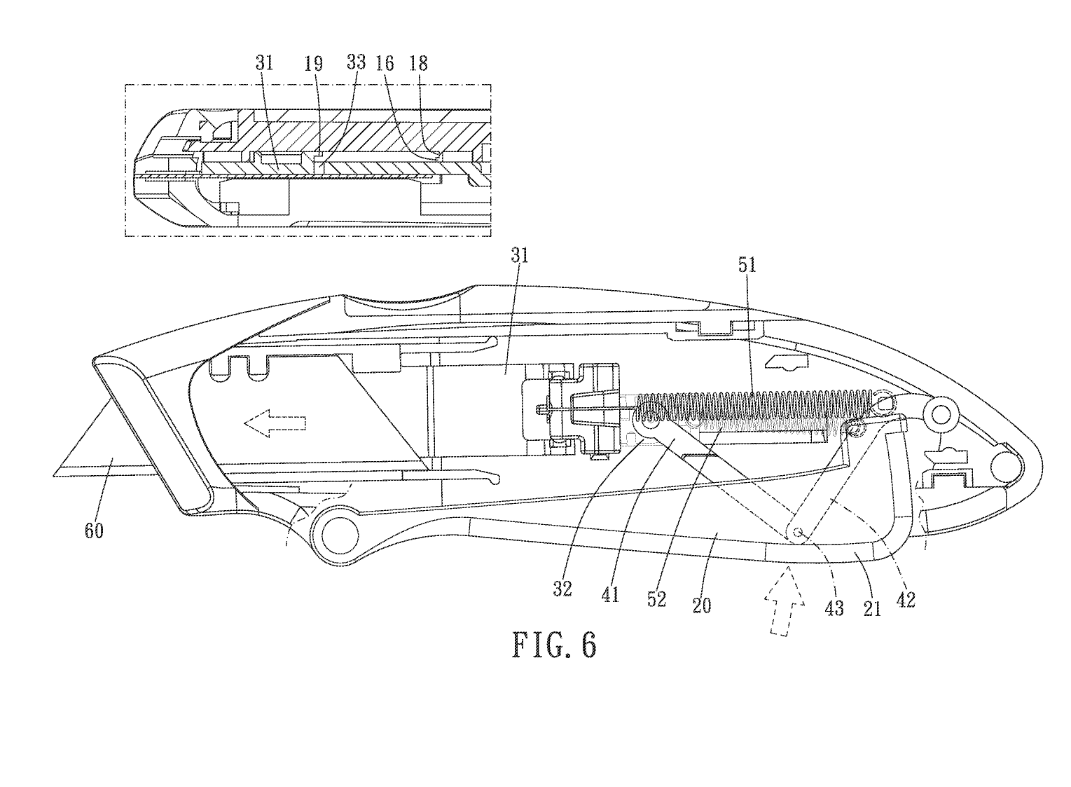

Please refer to FIGS. 1 to 7 for a preferred embodiment of the present invention. A box cutter structure 1 includes a shell 10, a swinging member 20, a blade carrier 30, a linkage mechanism 40 and an elastic recovery mechanism 50.

The shell 10 has a blade-projecting end 11 and a tail end 12 corresponding to the blade-projecting end 11. The shell 10 further includes a main shell 13 and a cover 14 which is detachably attached to the main shell 13. The swinging member 20 is pivoted to the shell 10 and extends toward the tail end 12 to form an abutting end 21 provided for the linkage mechanism 40 to abut thereagainst. The blade carrier 30 is slidingly disposed in the shell 10 and provided for carrying a blade 60. The linkage mechanism 40 includes a first linkage 41 and a second linkage 42, an end of the first linkage 41 is pivoted to the blade carrier 30, an end of the second linkage 42 forms an included angle with the first linkage 41 and is pivoted with the other end of the first linkage 41 to form a pivoting portion 43, the other end of the second linkage 42 is pivoted to the tail end 12, and the pivoting portion 43 is abuttable against the swinging member 20. The elastic recovery mechanism 50 is connected with the blade carrier 30 and the shell 10 and has a tendency to actuate the blade carrier 30 toward the tail end 12. The linkage mechanism 40 may include more than two linkages.

In this embodiment, the blade carrier 30 includes a blade carrying body 31 which is slidably disposed on the shell 10 and a sliding body 32 which is slidably disposed on the shell 10. The blade carrying body 31 and the sliding body 32 are arranged in a high-low configuration and are disposed near the blade-projecting end 11 and the tail end 12 respectively. The shell 10 is formed with a sliding slot 15 which is provided for the sliding body 32 to be slidably disposed therein. The sliding body 32 pushes and abuts against the blade carrying body 31 on which the blade 60 is disposed and projects the blade 60 out of the blade-projecting end 11.

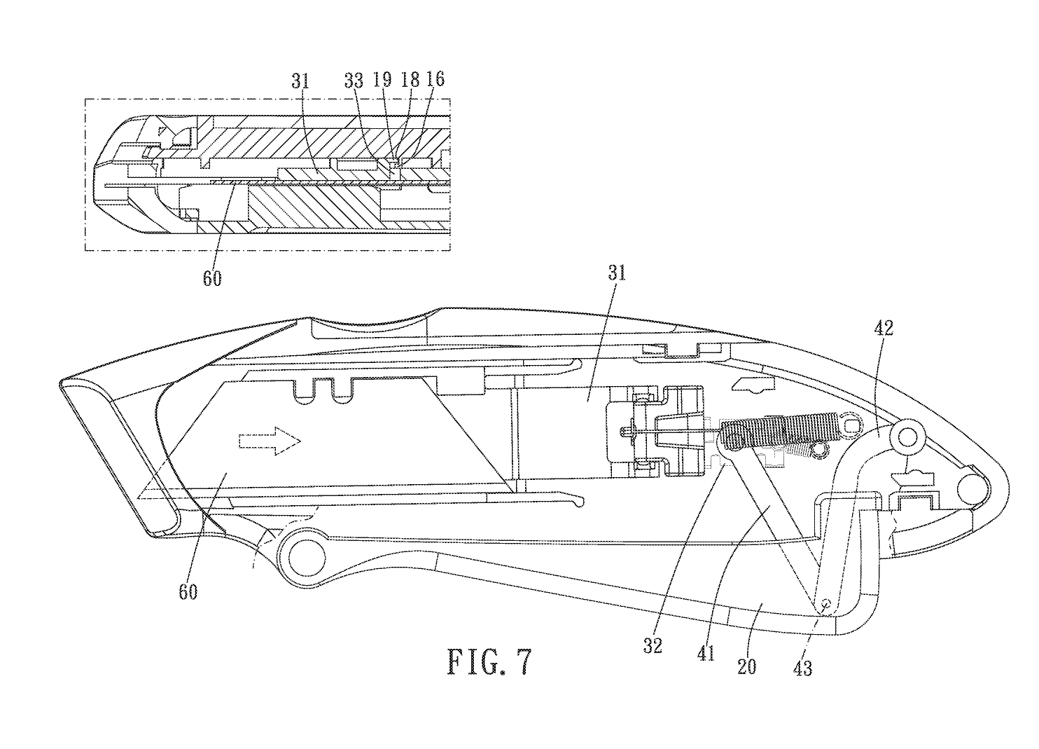

The shell 10 has a first blocking portion 16 facing the tail end 12, and the blade carrier 30 has a second blocking portion 17 facing the blade-projecting end 11. The second blocking portion 17 blocks the first blocking portion 16 in a sliding direction of the blade carrier 30. Preferably, one of the first and second blocking portions 16, 17 is formed with a restricting recess 18, and the other is formed with a restriction protrusion 19 which is cooperatively stuckable with the restriction recess 18. In this embodiment, the first blocking portion 16 is formed with a restricting recess 18, and the second blocking portion 17 is formed with a restricting protrusion 19. The restricting protrusion 19 and the restricting recess 18 stuck with each other (as shown in FIG. 7) to restrict a range that the blade carrier 30 is driven by the elastic recovery mechanism 50 and to stabilize the blade carrier 30. Preferably, the blade carrier 30 is formed with a through hole 33, and when the first and second blocking portions 16, 17 are blocked by each other, the through hole 33 is correspondingly above the second blocking portion 17 so as to make sure if the blade carrier 30 is correctly assembled.

The first linkage 41 includes two arm portions 44 positioned on different planes, and the two arm portions 44 are connected with the sliding body 32 of the blade carrier 30 in a relatively lower position and the second linkage 42 in a relatively higher position, respectively. When the blade carrying body 31 is a two-piece assembly which is pivotally connected, such a structure can make the blade carrying body 31 to carry out a seesaw movement so as to change a position or an angle of the blade. The second linkage 42 has a curved section 45 concave relative to the tail end 12, and a distal end of the curved section 45 is pivoted to the tail end 12; therefore, when a force is applied to the pivoting portion 43, a greater torque is generated to save the user more energy, and the curved section 45 can avoid the swinging member 20 to occupy less space.

An end of the swinging member 20 is formed with a blocking flange 22 which is abuttable against an inner side of the shell 10 and a guiding slot 23 which at least partially receives the first and second linkages 41, 42. Specifically, the swinging member 20 is a hollow shell, the guiding slot 23 is open facing an interior of the shell 10 and the pivoting portion 43 and part of the first and second linkages 41, 42 are slidably disposed in the guiding slot 23 so as to ensure that the first and the second linkages 41, 42 to work stably, enhance the connection of the first and the second linkages 41, 42 and elevate the pushing effect of the blade carrier 30.

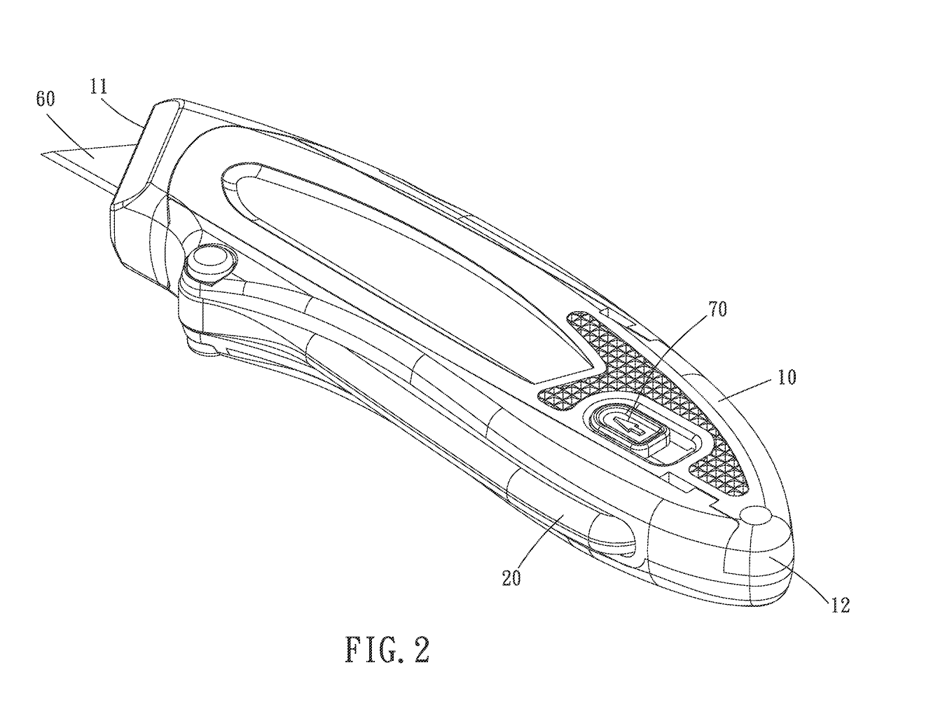

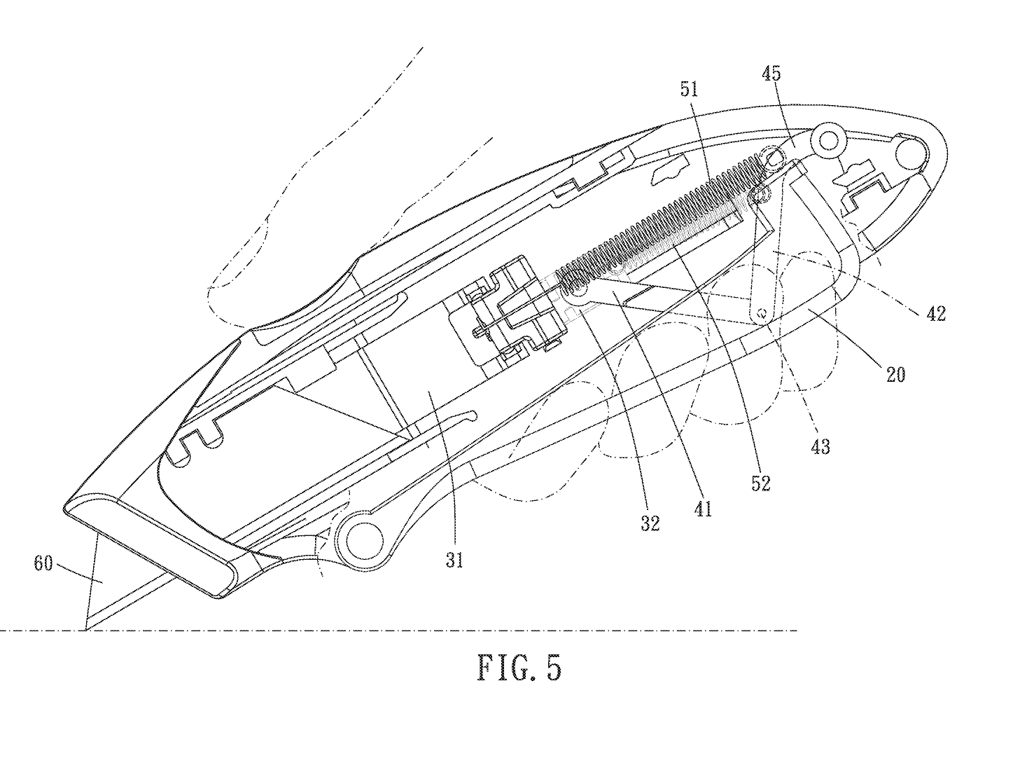

Preferably, the shell 10 is further formed with a locking member 70 which is switchable form outside. The locking member 70 has a blocking portion 71 which blocks the swinging member 20 on a pivoting path of the swinging member 20 selectively. Specifically, the locking member 70 is slidably inserted in the shell 10 via two lugs, and the two lugs are deep in the shell 10 and work as the blocking portion 71. When the locking member 70 is in a locking position (as shown in FIG. 1), one of the two lugs is on the pivoting path of the swinging member 20 so that the swinging member 20 cannot be pressed; when the locking member 70 is in a releasing position (as shown in FIG. 2), the two lugs are not on the pivoting path of the swinging member 20 so that the swinging member 20 can be pressed to push the blade carrier 30 and make the blade 60 project out of the shell 10; wherein, when in use, the swinging member 20 will be pressed continuously, and no other position-limiting structures or restriction structures are needed to keep the blade projecting outside the shell (as shown in FIG. 5).

The elastic recovery mechanism 50 includes a first elastic member 51 which is connected with the blade carrying body 31 and the shell 10 and a second elastic member 52 which is connected with the sliding body 32 and the shell 10. The first and second elastic members 51, 52 can be made of a coil spring or other elastic members, and the first and second elastic members 51, 52 can be extension spring or compression spring according to different structural configurations.

With the above-mentioned structure, when the swinging member 20 swings toward the shell 10, the pivoting portion 43 is pushed and abutted by the swinging member 20 and moves forward, and the first linkage 41 swings about the pivoting portion 43 and pushes the blade carrier 30 to move toward the blade-projecting end 11 to project the blade 60 out of the shell 10.

Given the above, with the box cutter structure, the user only needs to press the swinging member, and then the linkage mechanism will push the blade carrier to move forward to project the blade out of the shell. The present invention is easy, convenient and energy-saving for the user. In addition, the blade retreats automatically, so it is safe for the user.

In addition, preferably, the locking member is disposed so that when the box cutter structure is not used, the box cutter structure is locked to prevent the blade from projecting out accidentally.

While we have shown and described various embodiments in accordance with the present invention, it should be clear to those skilled in the art that further embodiments may be made without departing from the scope of the present invention.

What is claimed is:

1. A box cutter structure, including:
a shell, having a blade-projecting end and a tail end corresponding to the blade-projecting end;
a swinging member, pivoted to the shell and extending toward the tail end to form an abutting end;
a blade carrier, slidingly disposed in the shell and provided for carrying a blade;
a linkage mechanism, including a first linkage and a second linkage, an end of the first linkage pivoted to the blade carrier, an end of the second linkage forming an included angle with the first linkage and pivoted with the other end of the first linkage to form a pivoting portion, the other end of the second linkage pivoted to the tail end, the pivoting portion abuttable against the swinging member;
an elastic recovery mechanism, connected with the blade carrier and the shell, having a tendency to actuate the blade carrier toward the tail end;
wherein when the swinging member swings toward the shell, the pivoting portion is pushed and abutted by the swinging member and moves forward, and the first linkage swings about the pivoting portion and pushes the blade carrier to move toward the blade-projecting end.

2. The box cutter structure of claim 1, wherein the blade carrier includes a blade carrying body which is slidably disposed on the shell and a sliding body which is slidably disposed on the shell, the elastic recovery mechanism includes a first elastic member which is connected with the blade carrying body and the shell and a second elastic member which is connected with the sliding body and the shell.

3. The box cutter structure of claim 2, wherein the shell is formed with a sliding slot provided for the sliding body to be slidably disposed therein.

4. The box cutter structure of claim 1, wherein the shell has a first blocking portion facing the tail end, the blade carrier has a second blocking portion facing the blade-projecting end, and the second blocking portion blocks the first blocking portion in a sliding direction of the blade carrier.

5. The box cutter structure of claim 4, wherein one of the first blocking portion and the second blocking portion has a restricting recess, and the other has a restricting protrusion cooperatively stuckable with the restricting recess.

6. The box cutter structure of claim 4, wherein the blade carrier is formed with a through hole, and when the first and second blocking portions are blocked by each other, the through hole is correspondingly above the second blocking portion.

7. The box cutter structure of claim 1, wherein the first linkage includes two arm portions on different planes, and the two arm portions are connected with the blade carrier and the second linkage respectively.

8. The box cutter structure of claim 1, wherein the second linkage has a curved section concave relative to the tail end, and a distal end of the curved section is pivoted to the tail end.

9. The box cutter structure of claim 1, wherein an end of the swinging member is formed with a blocking flange abuttable against an inner side of the shell and a guiding slot which at least partially receives the first and second linkages.

10. The box cutter structure of claim 1, wherein the shell further has a locking member which is switchable from outside, and the locking member has a blocking portion which selectively blocks the swinging member on a swinging path of the swinging member.
